(19) United States
(12) Patent Application Publication
(10) Pub. No.: US 2021/0122947 A1
(43) Pub. Date: Apr. 29, 2021

(54) ADHESIVE SHEET, CONDUCTIVE MEMBER-LAYERED PRODUCT USING SAME, AND IMAGE DISPLAY DEVICE

(71) Applicant: Mitsubishi Chemical Corporation, Chiyoda-ku (JP)

(72) Inventors: Daiki TABATA, Chiyoda-ku (JP); Shinya FUKUDA, Chiyoda-ku (JP)

(73) Assignee: Mitsubishi Chemical Corporation, Chiyoda-ku (JP)

(21) Appl. No.: 17/042,685

(22) PCT Filed: Mar. 27, 2019
(86) PCT No.: PCT/JP2019/013261

§ 371 Date: Sep. 28, 2020

(30) Foreign Application Priority Data
Mar. 29, 2018 (JP) 2018-065697

(51) Int. Cl. C09J 7/38; C09J 7/10; C09J 11/06; C09J 133/08; C09J 123/22; B32B 7/12; G06F 3/044

(52) U.S. Cl. CPC C09J 7/385; C09J 7/383; C09J 7/10; C09J 11/06; C08K 5/3475; C09J 123/22; B32B 7/12; G06F 3/044; C09J 133/08

(57) ABSTRACT

Provided is a novel adhesive sheet capable of sufficiently exhibiting a corrosion prevention effect for silver and copper, and reducing the relative permittivity and its temperature dependency.

Proposed is an adhesive sheet of a single layer comprising an adhesive layer containing a polyolefin, an acrylic polymer, and a nitrogen heterocyclic compound; or an adhesive sheet having a layered constitution comprising the adhesive layer as a surface layer.

### TECHNICAL FIELD

The present invention relates to an adhesive sheet containing a rust inhibitor, a conductive member-layered product using the same, and an image display device.

### BACKGROUND ART

In recent years, display devices such as a liquid crystal display (LCD) and an organic EL display (OLED), and input devices such as a touch panel have been widely used in various fields. In producing such display devices and input devices, a transparent adhesive (Optical Clear Adhesive) sheet is used for bonding optical members. For example, an acrylic transparent adhesive sheet is frequently used for bonding optical members in various display devices such as a touch panel.

In such display devices and input devices, there is a problem that metal wiring and transparent electrodes are corroded by corrosive components contained in the transparent adhesive sheet and those entering the inside from the external environment. Further, with the recent increase in size of sensors and narrowing of frame edges, display devices and input devices comprising metal members such as copper wiring, silver mesh electrodes, and silver nanowire transparent electrodes, which are all more easily corroded, are increasing.

Therefore, methods for preventing corrosion by blending a rust inhibitor to a transparent adhesive sheet used for bonding optical members, have been proposed.

For example, Patent Document 1 proposes an adhesive layer containing an acrylic polymer (especially a hydroxyl group-containing acrylic polymer), a crosslinking agent, and a carboxybenzotriazole and/or 1,2,4-triazole compound, and discloses that discoloration or the like of the adhesive layer can be prevented in a contact test for copper.

Patent Document 2 discloses that an increase of the resistance value of copper electrodes can be slightly suppressed by containing a benzotriazole-based compound in an acid-free acrylic polymer containing no acidic group-containing monomer.

### CITATION LIST

### Patent Document

Patent Document 1: Japanese Patent Laid-Open No. 2012-046681

Patent Document 2: International Publication No. WO 2014/125914

### SUMMARY OF THE INVENTION

### Problem to be Solved by the Invention

With the transparent adhesive sheet obtained by simply adding a rust inhibitor to an acrylic polymer as in Patent Document 1, it has been difficult to exhibit corrosion prevention performance over a long period of time against metals that are easily corroded, such as silver and copper. In particular, when the transparent adhesive sheet as described above is arranged in the vicinity of a silver nanowire electrode, a phenomenon in which the resistance value increases during an environmental test is observed, and the durability of the touch panel sensor may be insufficient.

Further, even when a rust inhibitor is added to an acrylic polymer containing no acidic group-containing monomer as in Patent Document 2, a sufficient improvement effect is not observed on silver, copper, and the like, and the durability of the touch panel sensor may be insufficient.

Moreover, the transparent adhesive sheet containing a rust inhibitor, whose relative permittivity and its temperature dependency are too high, may lead to malfunction of the touch panel sensor.

Therefore, an object of the present invention is to provide a noble adhesive sheet capable of sufficiently exhibiting a corrosion prevention effect over a long period of time even for metals that are easily corroded, such as silver and copper, and in addition, reducing the relative permittivity and its temperature dependency.

### Means for Solving Problem

The present invention proposes an adhesive sheet of a single layer comprising an adhesive layer containing a polyolefin, an acrylic polymer, and a nitrogen heterocyclic compound.

The present invention also proposes an adhesive sheet having a layered constitution comprising an adhesive layer containing a polyolefin, an acrylic polymer, and a nitrogen heterocyclic compound, wherein the adhesive sheet is provided as a surface layer.

### Effect of the Invention

The adhesive sheet proposed by the present invention is able to reduce the relative permittivity and its temperature dependency, and to obtain a corrosion prevention effect by containing a polyolefin, an acrylic polymer, and a nitrogen heterocyclic compound in the adhesive layer. Here, when the total content of chlorine, bromine, iodine, and sulfur contained in the adhesive sheet is set to a certain value or less, corrosion prevention can be further improved, and thus, it is preferable to set the total content of chlorine, bromine, iodine, and sulfur to a certain value or less.

In addition, since the adhesive layer contains a polyolefin and an acrylic polymer, a rust inhibitor can be easily unevenly distributed on the surface of the adhesive layer compared with an adhesive layer containing no polyolefin. Therefore, when the adhesive sheet is laminated on the electrode, the metal surface can be rapidly protected by a nitrogen heterocyclic compound having a corrosion prevention function, and the corrosion prevention effect can be sufficiently exhibited even for silver and copper, which are easily corroded. Thus, an initial resistance value of the electrode made of, for example, silver or copper, which is easily corroded, can be maintained for a long period of time.

Further, when a mold release film is laminated on the adhesive layer, the nitrogen heterocyclic compound unevenly distributed on the adhesive layer surface is transferred to the mold release film, which can also contribute to preventing discoloration of the mold release film.

In accordance with the adhesive sheet proposed by the present invention, low permittivity, transparency, and corrosion prevention effect can be obtained, and thus it is possible to contribute to malfunction prevention of a touch panel sensor or the like and corrosion prevention of metal wiring such as silver nanowires and copper wiring while maintaining high transparency.

### BRIEF DESCRIPTION OF DRAWINGS

FIG. 1 is a graph plotting the results of Example 4 and Comparative Example 1 in the coordinates where an argon etching time (in seconds) when carbon, nitrogen, oxygen, and silicon are scanned 40 times at every 100 seconds using an X-ray electron spectroscopy while performing argon etching is taken on the horizontal axis, and N/C obtained by dividing the nitrogen atom concentration by the carbon atom concentration is taken on the vertical axis.

FIG. 2 is a schematic diagram showing the constitution of samples used for evaluation of corrosion resistance in Examples 1 to 5 and Comparative Examples 1 to 2, in which (A) is a top view and (B) is a side sectional view.

### MODE(S) FOR CARRYING OUT THE INVENTION

Next, the present disclosure will be described based on exemplary embodiments. However, the present disclosure is not limited to the embodiments that will be described below.

[Present Adhesive Sheet]

The adhesive sheet according to an example of the embodiments of the present invention (referred to as “present adhesive sheet”) is an adhesive sheet of a single layer comprising an adhesive layer containing at least a polyolefin, an acrylic polymer, and a nitrogen heterocyclic compound, or an adhesive sheet having a layered constitution comprising the adhesive layer as a surface layer.

That is, one embodiment of the present adhesive sheet is an adhesive sheet of a single layer comprising an adhesive layer containing at least a polyolefin, an acrylic polymer, and a nitrogen heterocyclic compound.

Another embodiment of the present adhesive sheet is an adhesive sheet having a layered constitution comprising the adhesive layer containing at least a polyolefin, an acrylic polymer, and a nitrogen heterocyclic compound provided as a surface layer.

The present adhesive sheet may be a double-sided adhesive sheet in which both front and back surfaces of the present adhesive sheet are adhesive layer surfaces, or may be a single-sided adhesive sheet in which only one surface is an adhesive layer surface. Among them, the double-sided adhesive sheet is preferable from the viewpoint of bonding two members. In addition, as long as the adhesive layer is provided as a surface layer on at least one side, another layer may be provided on the other side, or the adhesive layer may be provided on both sides of the other layer. In this case, as the other layer, a support layer can be cited.

In the present specification, the term “adhesive sheet” also includes a tape-like material, that is, “adhesive tape”.

Further, in the present specification, the surface of the adhesive agent layer may be referred to as “adhesive surface”.

<Acrylic Polymer>

The adhesive layer in the present adhesive sheet contains an acrylic polymer containing a (meth)acrylate unit. It is preferable to contain an acrylic polymer formed by polymerizing a (meth)acryloyl group-containing component.

When the adhesive layer contains an acrylic polymer, low-temperature flow of the adhesive layer can be suppressed.

From the viewpoint of compatibility with a polyolefin, the (meth)acryloyl group-containing component may be aliphatic (meth)acrylate, alicyclic (meth)acrylate, (meth)acryloyl group-modified polyolefin, or a combination thereof.

The aliphatic (meth)acrylate may be a monofunctional (meth)acrylate or a bifunctional or higher (meth)acrylate as long as it is a (meth)acrylate ester of a linear and/or branched alcohol.

Among them, it is preferably an acrylic acid ester of an alcohol having 10 to 30 carbon atoms, more preferably an acrylic acid ester of an alcohol having 12 to 24 carbon atoms, and even more preferably an acrylic acid ester of an alcohol having 12 to 20 carbon atoms.

When it is an acrylic acid ester of an alcohol having 10 or more carbon atoms, difference in solubility parameter with the polyolefin is small, and influence of phase separation and bleeding-out can be reduced. In addition, when it is an acrylic acid ester of an alcohol having 30 or lower carbon atoms, deterioration of transparency due to crystallization of the acrylic acid ester can be suppressed, and the glass transition temperature (Tg) of the adhesive layer can be adjusted to a room temperature or lower suitable for an adhesive agent.

Examples of the aliphatic (meth)acrylate may include isostearyl (meth)acrylate, isohexadecyl (meth)acrylate, stearyl (meth)acrylate, hexadecyl (meth) acrylate, isotetradecyl (meth) acrylate, tetradecyl (meth)acrylate, isododecyl (meth)acrylate, dodecyl (meth)acrylate, and isodecyl (meth)acrylate.

Examples of the alicyclic (meth)acrylate may include dicyclopentenyloxyethyl (meth) acrylate, dicyclopentanyl (meth) acrylate, tricyclodecane dimethanol diacrylate, isobornyl (meth)acrylate, and cyclohexanedimethanol mono (meth) acrylate.

Examples of the (meth)acryloyl group-modified polyolefin may include those having an acryloyl group at the terminal of polybutadiene (for example, NISSO-PBTE series, manufactured by Nippon Soda Co., Ltd.), those having an acryloyl group in the polyisoprene side chain (for example, Kuraprene UC-102M and UC-203M, manufactured by Kuraray Co., Ltd.), and polybutadiene-terminated urethane acrylate (for example, CN9014NS, manufactured by Arkema S.A.).

By using such a (meth)acryloyl group-modified polyolefin, it becomes compatible with the polyolefin to form a transparent adhesive layer.

In the above adhesive layer, the acrylic polymer preferably forms a three-dimensional network structure in which the aforementioned (meth)acryloyl group-containing component is crosslinked.

In order for the acrylic polymer to form a three-dimensional network structure, it is preferable that a polymerization initiator is blended when forming an adhesive layer, and the (meth)acryloyl group-containing component is subjected to a polymerization reaction (crosslinking), as described below.

Whether or not the acrylic polymer is crosslinked to form a three-dimensional network structure in the adhesive layer may be judged by measuring the gel fraction of the adhesive layer or the adhesive sheet and determining whether the gel fraction is 5% or more, more reliably 10% or more, and even more reliably 20% or more.

In Examples described later, since the (meth)acryloyl group-containing component capable of forming a three-dimensional network structure is subjected to a polymerization reaction (crosslinking), it can be presumed that the acrylic polymer in the adhesive layer is crosslinked to form a three-dimensional network structure, without measuring the gel fraction.

The content of the acrylic polymer in the adhesive layer of the present adhesive sheet is preferably 30% by mass or more, and more preferably 40% by mass or more. On the other hand, the upper limit thereof is preferably 70% by mass or less, and more preferably 60% by mass or less.

When the content of the acrylic polymer falls within the above range, the flow of the adhesive layer can be reduced, and the reliability at a high temperature can be improved.

<Polyolefin>

The adhesive layer in the present adhesive sheet is preferably composed of a polyolefin as an essential component.

By containing a predetermined polyolefin in the adhesive layer, the relative permittivity can be reduced, and the contents of chlorine, bromine, iodine, and sulfur can be reduced compared to the case where no polyolefin is contained. In addition, the nitrogen heterocyclic compound can be unevenly distributed in a high concentration in the vicinity of the surface of the adhesive layer, and the metal surface can be quickly protected by the triazole compound at the time of contact with metals. Hence, the corrosion prevention effect can be sufficiently exhibited even to an electrode made of extremely corrosive metals such as silver and copper.

In order to exhibit the flexibility required as an adhesive agent, the polyolefin preferably has a glass transition temperature (Tg) of 20° C. or lower, more preferably −60° C. or higher or 15° C. or lower, and even more preferably −55° C. or higher or 10° C. or lower.

From such a viewpoint, examples of the polyolefin may include a polymer of any one of polyisobutylene, polybutene, polybutadiene, and polyisoprene; a hydrogen additive polymer of any one thereof; a polymer having the polymer or hydrogen additive polymer of any one thereof as a main chain; a copolymer comprising a combination of monomers constituting the polymers or hydrogen additive polymers of any two or more thereof; and a mixed resin comprising a combination of the polymers of any two or more thereof. In addition, various elastomers known as olefin-based elastomers (TPO) are also preferable.

Examples of such polyolefins may include Oppanol (trade name of BASF SE), Tetrax (trade name of JXTG Holdings Inc.), Nisseki Polybutene (trade name of JXTG Holdings Inc.), and TAFMER BL (trade name of Mitsui Chemicals, Inc.).

The content of the polyolefin in the adhesive layer of the present adhesive sheet is preferably 30% by mass or more, and more preferably 40° by mass or more. On the other hand, the upper limit thereof is preferably 70° by mass or less, and more preferably 60° by mass or less.

When the content of the polyolefin falls within the above range, the moisture absorption of the adhesive layer can be reduced, and the generation of corrosive components caused by hydrolysis of the acrylic polymer can be suppressed. In addition, when the content of the polyolefin in the adhesive layer of the present adhesive sheet falls within the above range, the relative permittivity can be lowered, and the temperature dependence can be reduced. Furthermore, since the acrylic polymer is relatively decreased, the total content of Cl, Br, I, and S contained as impurities in the acrylic polymer, especially acrylic acid ester, can be reduced.

From the viewpoint that the contents of chlorine, bromine, iodine, and sulfur can be reduced and that a nitrogen heterocyclic compound can be unevenly distributed in a high concentration in the vicinity of the surface of the adhesive layer, the mass ratio of the content of the polyolefin to the content of the acrylic polymer is preferably 50 to 200%, more preferably 60% or more or 180% or less, and even more preferably 70% or more or 160% or less.

In addition, from the viewpoint that a nitrogen heterocyclic compound can be unevenly distributed in a high concentration in the vicinity of the surface of the adhesive layer, the content mass of the polyolefin is preferably 50 to 500 times the content mass of the nitrogen heterocyclic compound, more preferably 75 times or more or 450 times or less, and even more preferably 100 times or more or 400 times or less.

<Nitrogen Heterocyclic Compound>

The adhesive layer of the present adhesive sheet is preferably composed of a nitrogen heterocyclic compound having a rust preventive function to metals, as an essential component.

The nitrogen heterocyclic compound is a general term for compounds containing a saturated or unsaturated ring structure of three or more membered-ring containing a nitrogen element; and examples of the ring structure may include imidazole, pyrazole, oxazoline, imidazoline, morpholine, triazole, tetrazole, pyridazine, pyrimidine, pyrazine, indole, isoindole, benzimidazole, purine, quinoline, isoquinoline, quinazoline, quinoxaline, cinnoline, pteridine, acridine, carbazole, adenine, guanine, cytosine, thymine, and uracil.

These nitrogen heterocyclic compounds are known to act as inhibitors for metal rust and corrosion. From the viewpoint that they are available at low cost, have a high rust prevention effect, and have compatibility with the above-mentioned polyolefins and acrylic polymers and transparency, as well as the viewpoint that it is hard to inhibit the reactions (crosslinking and polymerization) when reacting the (meth)acryloyl group-containing component after the addition, a triazole compound, a pyrazole compound, an imidazoline compound, an imidazole compound, and a tetrazole compound are preferable, and a triazole compound is more preferable.

The triazole compound is not particularly limited as long as it is a compound having a triazole skeleton. In addition to the triazoles, benzotriazoles and the like can be cited.

Examples of the benzotriazole may include 1,2,3-triazole, 1,2,4-triazole, 1,2,3-benzotriazole, 1-[N,N-bis(2-ethylhexyl)aminomethyl]benzotriazole, 1-[N,N-bis(2-ethylhexyl)aminomethyl]methylbenzotriazole, 2,2′-[[(methyl-1H-benzotriazol-1-yl)methyl]imino]bisethanol, 3,5-dimethyl-1,2,4-triazole, and 3,5-diamino-1,2,4-triazole.

Among them, a liquid 1,2,3-triazole is preferable from the viewpoint of preventing precipitation in the adhesive layer.

The nitrogen heterocyclic compound may be used singly or in combination of two or more kinds thereof.

The content of the nitrogen heterocyclic compound is not particularly limited. Among others, the content thereof is preferably 0.01 to 10 parts by mass, more preferably 0.02 part by mass or more or 8 parts by mass or less, and even more preferably 0.05 part by mass or more or 5 parts by mass or less, relative to 100 parts by mass of the adhesive layer.

The content of the nitrogen heterocyclic compound is preferably 0.01 part by mass or more since good corrosion prevention performance is easily obtained. On the other hand, the content thereof is preferably 10 parts by mass or less since transparency is easily secured, and adhesion reliability such as foam peeling resistance is easily secured.

The Hansen solubility parameter (HSP) can be used for controlling uneven distribution of the nitrogen heterocyclic compound in the adhesive layer of the present adhesive sheet.

That is, the HSP distance between the nitrogen heterocyclic compound and the polyolefin is preferably 18.0 or more, more preferably 20.0 or more, and even more preferably 25.0 or more. When the distance is 18.0 or more, the nitrogen heterocyclic compound is easily unevenly distributed on the surface of the adhesive layer, and for example, when the adhesive sheet is laminated on an electrode, the nitrogen heterocyclic compound is able to act on the electrode earlier than corrosion-causing substances. The upper limit is not particularly limited, but is generally 30.0 or less.

The “Hansen solubility parameter (HSP)” is an index representing the solubility how much a substance dissolves in some other substance.

The HSP is represented as a three-dimensional space in which a solubility parameter introduced by Hildebrand is divided into three components of a dispersion term δD, a polar term δP, and a hydrogen bond term δH. The dispersion term δD represents the effect of dispersion force, the polar term δP represents the effect of dipole-dipole force, and the hydrogen bond term δH represents the effect of hydrogen bond force, and these are explained as follows (Here, each unit is MPa^{0.5}.):

δD: energy derived from dispersion force between molecules

δP: energy derived from polar force between molecules

δH: energy derived from hydrogen bond force between molecules

Definitions and calculations of the HSP are described in the following document:

Charles M. Hansen, Hansen Solubility Parameters: A Users Handbook (CRC Press, 2007).

The dispersion term reflects van der Waals force, the polar term reflects the dipole moment, and the hydrogen bond term reflects the action of water, alcohol, or the like. The ones whose vectors by the HSP are similar can be determined to have high solubility, and the similarity of the vectors can be determined by the distance of the Hansen solubility parameter (HSP distance). The Hansen solubility parameter can be an index not only for determining the solubility, but also for determining how easily a certain substance is present in another certain substance, that is, how good the dispersion is.

In the present invention, the HSP [δD, δP, δH] can be easily estimated from its chemical structure by using, for example, computer software “Hansen Solubility Parameters in Practice (HSPiP)”. Specifically, it is obtained from the chemical structure by a Y-MB method implemented in the HSPiP. When the chemical structure is unknown, it is determined by a sphere method implemented in the HSPiP from the results of dissolution tests using a plurality of solvents.

The HSP distance (Ra) can be calculated by the following formula when, for example, the HSP of a solute (for example, nitrogen heterocyclic compound) is (δD1, δP1, δH1), and the HSP of a solvent (for example, polyolefin) is (δD2, δP2, δH2):

HSP distance (Ra)={4×(δD1-δD2)²+(δP1-δP2)²+(δH1-δH2)²}^{0.5}

The HSP distance can be adjusted by selecting various nitrogen heterocyclic compounds and polyolefins to be used.

<Other Components>

Other components such as a crosslinking agent, a plasticizer, a UV absorber, a HALS, a silane coupling agent, aerosil, and a nanofiller can be added to the adhesive layer if necessary.

<Thickness>

The thickness of the present adhesive sheet is not particularly limited. In a display application including a touch panel, the thickness is preferably 5 μm or more and 1,000 μm or less, and more preferably 10 μm or more or 500 μm or less.

When the thickness of the present adhesive sheet is 5 μm or more, a practical effect of preventing metal corrosion can be exhibited, and when the thickness thereof is 1,000 μm or less, transparency and handling properties are good.

[Characteristics of Present Adhesive Sheet]

The present adhesive sheet can have the following characteristics.

<Total Content of Cl, Br, I, and S in Adhesive Layer>

In the present adhesive sheet, the total content (mass) of Cl, Br, I, and S is preferably 100 ppm or less, more preferably 80 ppm or less, and even more preferably 50 ppm or less.

Furthermore, the total content (mass) of Cl, Br, I, and S is preferably 100 ppm or less, more preferably 80 ppm or less, and even more preferably 50 ppm or less as a concentration of the adhesive layer.

When the total content of Cl, Br, I, and S falls within the above range, the corrosion of copper and silver can be more effectively suppressed through a synergistic effect with the rust inhibitor.

As a method for controlling the total content of Cl, Br, I, and S to the above range in the present adhesive sheet, a method in which the content of each element is controlled by adjusting a production method of the (meth)acryloyl group-containing component, or a method in which the conditions are controlled by washing the (meth)acryloyl group-containing component, can be cited. However, it is not limited to these methods.

For example, when the (meth)acryloyl group-containing component is produced by a transesterification method, at least the content of S can be reduced more than by a dehydrative esterification method.

The contents of Cl, Br and S can be measured by the following quantitative method.

A sample is combusted and decomposed by a sample combustion device (AQF-200M, manufactured by Mitsubishi Chemical Analytech Co., Ltd.), and the generated gas is collected in an absorbent to form a sample solution. The contents of Cl, Br, and S in the sample solution can be quantified by a calibration curve method using an ion chromatography (ICS-1600, manufactured by Thermo Fisher Scientific K. K.).

On the other hand, the content of I can be measured by the following quantitative method.

A sample is combusted and decomposed by a sample combustion device (AQF-200M; manufactured by Mitsubishi Chemical Analytech Co., Ltd.), and the generated gas is collected in an absorbent to form a sample solution. The content of I in the sample solution is quantified by a calibration curve method using an inductively coupled plasma mass spectrometer (Agilent 7500, manufactured by Agilent Technologies, Inc.).

<Uneven Distribution of Nitrogen Heterocyclic Compound>

In the adhesive layer of the present adhesive sheet, it is preferable that the nitrogen heterocyclic compound is more unevenly distributed on the adhesive layer surface than the inside of the adhesive layer. In other words, it is preferable that the concentration of the nitrogen heterocyclic compound on the adhesive layer surface is higher than that of the inside of the adhesive layer.

Since the adhesive layer in the present adhesive sheet contains the polyolefin in addition to the acrylic polymer, the nitrogen heterocyclic compound can be more unevenly distributed on the surface of the adhesive layer compared with an adhesive layer containing no polyolefin. By unevenly distributing the nitrogen heterocyclic compound having a corrosion prevention function on the surface of the adhesive layer as described above, for example, when the present adhesive sheet is laminated on an electrode, the nitrogen heterocyclic compound is able to act on the electrode earlier than corrosion-causing substances, so that the corrosion can be prevented more effectively.

Whether or not the nitrogen heterocyclic compound is unevenly distributed on the adhesive layer surface can be confirmed, for example, by the following method.

When a triazole compound is used as the nitrogen heterocyclic compound, the triazole compound used in the present adhesive sheet contains a large number of nitrogen atoms in the molecule. Therefore, the presence or absence of unevenly distributed triazole compound in the adhesive layer and the concentration distribution can be known by measuring the concentration of the nitrogen atoms with an X-ray electron spectroscopy (called ESCA, or XPS). In particular, the concentration gradient of the atoms on the surface and inside thereof can be known by observing the depth-direction profile (depth profile) of each atom obtained by scanning while performing argon (Ar) etching.

As the X-ray electron spectroscopy analyzer, K-Alpha, manufactured by Thermo Fisher Scientific Inc. or the like can be used, and a satisfactory depth profile can be obtained by scanning 40 times or more at every 100 seconds while performing Ar etching.

It is preferable to scan at least four of carbon, oxygen, silicon, and nitrogen, and it is more accurate to evaluate the concentration of the nitrogen atoms by the relative amount with carbon atoms. Therefore, it is preferable to confirm the depth profile with a graph in which the value (N/C) obtained by dividing the nitrogen atom concentration by the carbon atom concentration is taken on the vertical axis, and the etching time is taken on the horizontal axis.

When confirmed by such a graph, the adhesive sheet of the present invention has a gradient in the nitrogen atom concentration on the surface side and the inner side. That is, a concentration gradient is observed in the triazole compound.

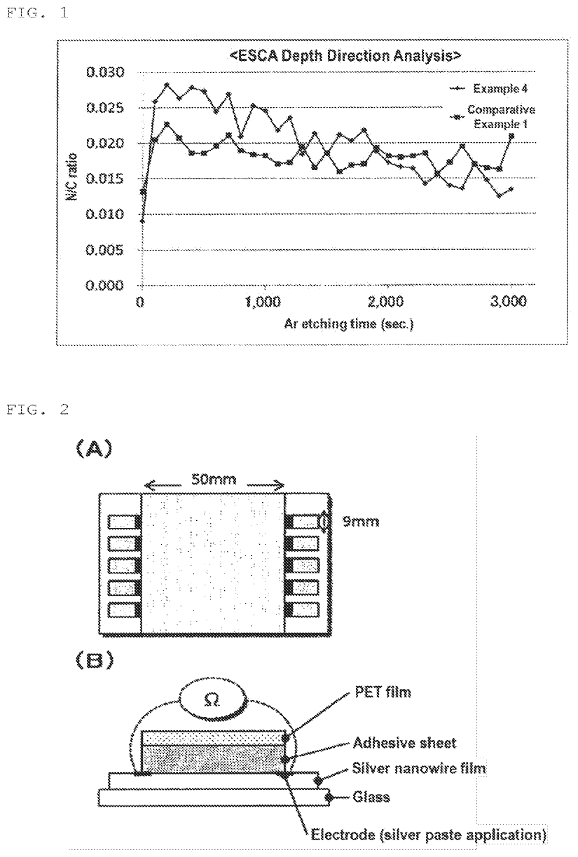

In particular, the N/C on the very surface at 100 seconds after Ar etching is preferably larger than the N/C at 4,000 seconds after Ar etching, by 0.01 or more, and more preferably 0.015 or more. When the difference is larger than 0.01, the metal surface can be more efficiently protected by the triazole compound. An example of the analysis results is shown in FIG. 1.

Specifically, for example, when the etching is performed under the following etching conditions, the N/C at about several nm (nanometer) from the surface can be measured when the etching time is 100 seconds, and the N/C at about 0.8 pm from the surface can be measured when the etching time is 4,000 seconds.

<Measurement Conditions>

Measurement area: ϕ400 μm

Path energy: 50 eV

Number of scanning times: 5 times

<Etching Conditions>

Ion energy: 1,000 eV

Raster size: ϕ2 mm

When a nitrogen source of the triazole compound is present, it can be measured by time-of-flight secondary ion mass spectrometry (TOF-SIMS) or the like instead.

<Haze>

The haze of the present adhesive sheet (according to Japanese Industrial Standard (JIS) K7136) is not particularly limited. Among others, the haze is preferably 1.0° or less, and more preferably 0.8° or less. The haze is preferably 1.0% or less since excellent transparency and appearance can be obtained.

The haze can be measured by a method in which, for example, the adhesive sheet is left to stand in a normal state (23° C., 50% RH) for at least 24 hours; a separator, if present, is peeled off; a sample obtained by bonding the adhesive sheet to a slide glass (for example, one having a total light transmittance of 91.8% and a haze of 0.4%) is used; and the measurement is performed using a haze meter (product name “HM-150”, manufactured by Murakami Color Research Laboratory Co., Ltd.).

<Total Light Transmittance>

The total light transmittance of the present adhesive sheet is preferably 90% or more, and more preferably 91% or more, from the viewpoint of transparency in consideration of applications to displays.

<Relative Permittivity>

The present adhesive sheet preferably has a relative permittivity of 3.8 or less, and more preferably 3.0 or less at a frequency of 100 kHz.

When the relative permittivity falls within the above range, electrostatic capacity as an insulating layer can be reduced, and malfunction of the touch panel-type input/output device due to high frequency noise can be prevented. In addition, the adhesive layer can be made thinner, which contributes to space savings and bending of image display devices.

The relative permittivity can be controlled to the above range by adjusting the amount ratio of the polyolefin contained in the adhesive sheet to be used. However, it is not limited to this method.

<Glass Transition Temperature>

The present adhesive sheet preferably has a glass transition temperature (Tg) in a range of −30° C. to 30° C. When the glass transition temperature (TG) falls within the range of −30° C. to 30° C., an adhesive sheet having good adhesiveness and holding force can be obtained.

In order to adjust the glass transition temperature (Tg) of the present adhesive sheet to the above range, a method of selecting the types of polyolefins and (meth)acryloyl group-containing components, as well as the mixing ratios thereof can be adopted, as described later. The glass transition temperature can also be controlled to the range of −30° C. to 30° C. by adding a tackifier. However, it is not limited to these methods.

Here, the “glass transition temperature” refers to a temperature at which a peak of main dispersion of loss tangent (tan δ) appears.

<Method for Producing Present Adhesive Sheet>

Next, a method for producing the present adhesive sheet will be described.

However, the following description is an example of methods for producing the present adhesive sheet, and the present adhesive sheet is not limited to that produced by such a method.

The present adhesive sheet can be obtained by a method in which an adhesive layer-forming composition (referred to as “present adhesive layer- forming composition”) containing a polyolefin, a (meth)acryloyl group-containing component, a nitrogen heterocyclic compound, optionally a cleavage-type photopolymerization initiator, and optionally other materials is molded into an uncured sheet; and the sheet is then cured by polymerizing the (meth)acryloyl group-containing component. However, it is not limited to this method.

As a method for molding the present adhesive layer-forming composition into an uncured sheet, known methods such as a dry lamination method, an extrusion casting method using a T-die, an extrusion laminating method, a calendaring method, an inflation method, and the like can be adopted. Among them, a method of melt molding, such as an extrusion casting method or an extrusion laminating method, is preferable from the viewpoint of handling properties and productivity.

In the case of selecting a melt molding method not using a solvent, the present adhesive layer-forming composition for melt molding preferably has a storage elastic modulus (G′) of 50,000 Pa or more at 20° C., and 10,000 Pa or less at 160° C. at a shear of a frequency of 1 Hz in an uncured state. When the G′ at 20° C. falls within the above range, the shape can be maintained at room temperature after molding. In addition, when the G′ at 160° C. falls within the above range, the molding can be performed without entraining air bubbles.

The elastic modulus (storage elastic modulus) G′, the viscosity (loss elastic modulus) G″, and tan δ=G″/G′ at various temperatures can be measured using a strain rheometer.

It is preferable that the molding temperature at the time of melt molding is appropriately adjusted depending on the flow characteristics, film-forming properties, and the like.

The temperature is preferably 20° C. to 230° C., more preferably 20° C. to 160° C., and even more preferably 20° C. to 130° C.

In the case of melt molding, the thickness of the sheet can be appropriately adjusted by the lip gap of the T-die, the take-up speed of the sheet, and the like.

The present adhesive layer-forming composition can be cured by irradiating with heat and/or active energy rays and polymerizing the (meth)acryloyl group-containing component. For example, the present adhesive sheet can be cured by molding the present adhesive layer-forming composition into a sheet and irradiating with heat and/or active energy rays.

Here, examples of the active energy rays to be irradiated may include ionizing radiation such as α-rays, β-rays, γ-rays, neutron rays, and electron beams, ultraviolet light, and visible light; and among them, ultraviolet light is preferable from the viewpoint of suppressing damage to optical device constituent members and of the reaction control.

The irradiating energy, irradiating time, and irradiating method of the active energy rays are not particularly limited as long as the (meth)acryloyl group-containing component can be polymerized by activating the polymerization initiator.

As another embodiment of the method for producing the present adhesive sheet, as described below, a method in which the present adhesive layer-forming composition is dissolved in an appropriate solvent and various coating methods are used, can be cited. However, in this embodiment, it is necessary to consider the cost of production in terms of solvent recovery.

In the case of using the coating method, the present adhesive sheet can also be obtained by heat curing in addition to the above active energy ray irradiation curing.

In the case of selecting a molding method by coating, it is also effective to cure by heat curing in addition to curing by active energy rays. In this case, it is preferable to select a thermal polymerization initiator having a decomposition temperature higher than the drying temperature of the solvent.

In the case of coating, the thickness of the sheet can be adjusted by the coating thickness and the solid content concentration of the coating liquid.

Alternatively, embossing and various kinds of unevenness (cone shape, pyramid shape, hemispherical shape, and the like) processing may be performed as necessary. In addition, for the purpose of improving adhesion to various adherend parts, various surface treatments such as a corona treatment, a plasma treatment, and a primer treatment may be performed on the surface.

(Polymerization Initiator)

In the polymerization reaction in forming the adhesive layer, as described above, a polymerization initiator such as a thermal polymerization initiator or a photopolymerization initiator (photoinitiator) can be used depending on the type of the polymerization reaction. The polymerization initiator may be used singly or in combination of two or more kinds thereof.

The type of the photopolymerization initiator is not particularly limited. Examples thereof may include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator. The photopolymerization initiator may be used singly or in combination of two or more kinds thereof.

Examples of the benzoin ether-based photopolymerization initiator may include benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether.

Examples of the acetophenone-based photopolymerization initiator may include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone. Examples of the α-ketol-based photopolymerization initiator may include 2-methyl-2-hydroxypropiophenone and 1-[4-(2-hydroxyethyl)phenyl]-2-methylpropane-1-one.

Examples of the aromatic sulfonyl chloride-based photopolymerization initiator may include 2-naphthalene sulfonyl chloride.

Examples of the photoactive oxime-based photopolymerization initiator may include 1-phenyl-1,1-propanedione-2-(o-ethoxycarbonyl)-oxime.

Examples of the benzoin-based photopolymerization initiator may include benzoin.

Examples of the benzyl-based photopolymerization initiator may include benzyl. Examples of the benzophenone-based photopolymerization initiator may include benzophenone, benzoylbenzoic acid, 3,3′-dimethyl-4-methoxybenzophenone, polyvinyl benzophenone, and α-hydroxycyclohexyl phenyl ketone.

Examples of the ketal-based photopolymerization initiator may include benzyl dimethyl ketal.

Examples of the thioxanthone-based photopolymerization initiator may include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The amount of the photopolymerization initiator used is not particularly limited. For example, it is preferably 0.001 to 2 parts by mass, and more preferably 0.01 to 1 part by mass, relative to 100 parts by mass of the adhesive layer.

The type of the thermal polymerization initiator is not particularly limited. Examples thereof may include an azo-based polymerization initiator, a peroxide-based polymerization initiator (for example, dibenzoyl peroxide and tert-butyl permaleate), and a redox-based polymerization initiator.

The amount of the thermal polymerization initiator used is not particularly limited. For example, in the case of the peroxide-based polymerization initiator, it is preferably 0.05 to 0.5 part by mass, and more preferably 0.1 to 0.3 part by mass, relative to 100 parts by mass of the adhesive layer.

<Other Components>

Other components such as a plasticizer, a UV absorber, a HALS, a silane coupling agent, aerosil, acrylamide, and a nanofiller can be added to the adhesive layer-forming composition if necessary.

[Application of Present Adhesive Sheet]

The present adhesive sheet can be used as, for example, a laminated sheet having a constitution in which a mold release film is laminated on at least one surface or both surfaces of the present adhesive sheet.

The present adhesive sheet can also be used as a laminated sheet having a constitution in which a support film is laminated on at least one surface of the present adhesive sheet and a mold release film is laminated on the other surface thereof.

Here, the above laminated sheet having a constitution in which a mold release film is laminated on at least one surface of the present adhesive sheet can be obtained by irradiating with heat and/or active energy rays for curing treatment.

By laminating the mold release film on at least one surface of the present adhesive sheet as described above, blocking can be prevented, and adhesion of foreign materials can be prevented.

When the present adhesive sheet is stored with the mold release film laminated on at least one surface thereof, the nitrogen heterocyclic compound in the adhesive sheet is transferred to the mold release film. As a result, a laminated sheet having the nitrogen heterocyclic compound can be obtained on the surface on which the adhesive sheet in the mold release film is laminated. The mold release film in the laminated sheet contains the nitrogen heterocyclic compound, which can contribute to preventing discoloration of the mold release film.

<Conductive Member-Layered Product>

A conductive member-layered product (referred to as “present conductive member-layered product”) comprising the present adhesive sheet and a conductive member can also be used.

Examples of the conductive member may include a transparent conductive layer, and the present conductive member-layered product can be obtained by bonding the present adhesive sheet to the conductive layer surface of the transparent conductive layer. In this case, the present conductive member-layered product may have a constitution in which one of the adhesive layer surfaces of the present adhesive sheet and the conductive layer surface of the transparent conductive layer are bonded together. When the present adhesive sheet is a double-sided adhesive sheet, it may have a constitution in which both adhesive layer surfaces of the present adhesive sheet and the conductive layer surface of the transparent conductive layers are bonded together.

The transparent conductive layer may be formed with an insulating protective film made of an olefinic polymer, a urethane polymer, an epoxy polymer, an acrylic polymer, a silicone polymer, or an inorganic glass so as to cover the conductive layer surface of the conductive film.

The present conductive member-layered product obtained by bonding with the conductive layer surface can be suitably used, for example, in a touch panel.

Examples of the touch panel type may include a resistive film type, an electrostatic capacity type, and an electromagnetic induction type; and an electrostatic capacity type is preferable.

The transparent conductive layer may have a conductive layer on at least one surface, and examples thereof may include a transparent conductive layer in which a conductive substance is provided on the surface layer of a transparent substrate by vapor deposition, sputtering, coating, or the like.

Examples of the conductive substance used for the conductive layer of the transparent conductive layer may include metal oxides such as indium oxide, indium-gallium-zinc composite oxide, indium tin oxide (ITO), zinc oxide, gallium oxide, and titanium oxide; and metal materials such as silver, copper, molybdenum, and aluminum. Among them, indium tin oxide (ITO) and indium-gallium-zinc composite oxide, which are excellent in transparency, are preferable. In addition, copper and silver can also be preferably used from the viewpoint of excellent conductivity.

The substrate on which the conductive substance is patterned in the transparent conductive layer is not particularly limited, and examples thereof may include glass and resin film.

The transparent conductive layer preferably has a conductive layer on at least one surface layer thereof. Typically, a conductive pattern (wiring pattern) containing copper as a main component is formed on the transparent conductive layer so as to pattern the peripheral portion.

The present adhesive sheet can be suitably used especially for a conductive member having a conductive pattern formed of a metal material containing copper.

<Image Display Device>

The present conductive member-layered product can constitute, for example, an image display device (referred to as “present image display device”) having an image display panel and a surface protection panel.

For example, an image display device having a constitution in which the present conductive member-layered product obtained by bonding the present adhesive sheet to the conductive layer surface of the transparent conductive layer is interposed between an image display panel and a surface protection panel can be cited. Here, the present adhesive sheet can be used also on the image display panel side.

The material of the surface protection panel may be glass or a plastic such as an acrylic resin, a polycarbonate-based resin, an alicyclic polyolefin-based resin such as a cycloolefin polymer, a styrene-based resin, a polycarbonate-based resin, a phenol-based resin, a melamine-based resin, or an epoxy-based resin.

The image display panel is composed of a polarization film, an optical film such as a retardation film, a liquid crystal material, and a backlight panel. The type of the image display panel may be an STN-type, a VA-type, or an IPS-type depending on the control method of the liquid crystal material, and any type of the image display panel may be used.

<Explanation of Terms and Phrases>

According to the definition of Japanese Industrial Standard (JIS), a “sheet” is generally a thin and flat product having a thickness that is smaller than the length and the width thereof, and a “film” is generally a product having a thickness that is extremely smaller than the length and the width thereof, and having a maximum thickness that is arbitrarily determined, which is generally supplied in the form of a roll (Japanese Industrial Standard, JIS K6900). However, there is no definite boundary between the sheet and the film, and there is no need of literally distinguishing these terms. In the present invention, accordingly, the case referred to as a “film” is assumed to include a “sheet”, and the case referred to as a “sheet” is assumed to include a “film”.

In addition, in the case of expressing as the “panel” such as an image display panel and a protective panel, it is intended to include a plate body, a sheet, and a film.

In the case of being described as the term “X to Y” (X and Y represent arbitrary numbers) in the present specification, unless otherwise stated, the term includes the meaning of “preferably more than X” or “preferably less than Y” along with the meaning “not less than X and not more than Y”.

Also, unless otherwise stated, “X or more” (X represents an arbitrary number) includes the meaning of “preferably more than X”, and unless otherwise specified, “Y or less” (Y represents an arbitrary number) includes the meaning of “preferably less than Y”.

### EXAMPLES

The present invention will be further described with reference to Examples below. The present invention is not limited to the following Examples.

In each of Examples 1 to 5 and Comparative Examples 1 and 2, an adhesive layer-forming composition blended in the mass ratio shown in Table 1 was prepared, and laminated on a mold release film (PET film, manufactured by Mitsubishi Chemical Corporation) having a thickness of 100 pm, which was subjected to a silicone release treatment, such that the thickness of the adhesive layer was 100 μm.

Next, in each of Examples 1 to 5 and Comparative Example 2, a mold release film (PET film, manufactured by Mitsubishi Chemical Corporation) having a thickness of 75 μm, which was subjected to a silicone release treatment, was further laminated on the adhesive layer to form a layered product; and the layered product was irradiated with light using a metal halide lamp jrradiator (UVC-0516S1, lamp: UVL-8001M3-N, manufactured by Ushio Inc.) such that the irradiation amount at a wavelength of 365 nm was 2,000 mJ/cm², thereby obtaining an adhesive sheet-layered product having a mold release film lamlnated on both front and back sides of the adhesive layer.

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| Polyolefin | A-1 | Mass | 32.1 | 32.1 | 32.1 | | | | 32.1 |
| | A-2 | ratio | 16.5 | 16.5 | 16.5 | | | | 16.5 |
| | A-3 | | 6 | 6 | 6 | | | | 6 |
| | A-4 | | | | | 45.4 | 40 | | |
| | A-5 | | | | | | 5.4 | | |
| (Meth)acryloyl | B-1 | | | | | | | | |
| group | B-2 | | 35.3 | 35.3 | 17.6 | 20 | 20 | | 17.6 |
| containing | B-3 | | | | 17.6 | 16 | 16 | | 17.6 |
| component | B-4 | | 8.8 | 8.8 | 8.8 | 0.8 | 0.8 | | 8.8 |
| | B-5 | | | | | 6.4 | 6.4 | | |
| Acrylic | BA/LA/HBA = | | | | | | | 99.9 | |
| adhesive-1 | 60/40/1 | | | | | | | | |
| | (D110N:0.5) | | | | | | | | |
| Nitrogen | C-1 | | 0.25 | | 0.25 | 0.1 | 0.25 | 0.1 | |
| heterocyclic | C-2 | | | 0.25 | | | | | |
| compound | | | | | | | | | |
| Polymerization | Omnirad | | 0.5 | | | | | | |
| initiator | 651 | | | | | | | | |
| | Omnirad | | | 0.5 | 0.5 | 0.5 | 0.5 | | 0.5 |
| | TPO-G | | | | | | | | |
| Tackifier | Quinton | | | | | 10 | 10 | | |
| | R100 | | | | | | | | |
| Antioxidant | Irganox | | 0.64 | 40.64 | 0.6 | 0.64 | 0.64 | | 0.6 |
| | 1076 | | | | | | | | |

The compounds described. in Table I are as follows:

A-1 is Oppanol NSOSF (polyiso-butene, number average molecular weight (Mn): 235,400, mass average molecular weight (Mw): 565,000, HSP: δD=15.1, δP=0, δH=0, Tg: −30° C., manufactured by BASF);

A-2 is Tetrax 3T (polyiso-butene, number average molecular weight (Mn): 21,400, mass average molecular weight (Mw): 49,000, HSP: δD=15.1, δP=0, δH=0, Tg: −30° C., manufactured by JXTG);

A-3 is IP solvent 2835 (C16-C24 isoparaffin 100% by mass, mass average molecular weight (Mw): 300 or less, HSP: δD=15.1, δP=0, δH=0, Tg: unmeasurable, manufactured by Idemitsu);

A-4 is polybutene (isobutene-normal butene copolymer, normal butene amount: 4° , number average molecular weight: 1,660, mass average molecular weight: 3,718, HSP: δD=15.1, δP=0, δH=0.1, Tg: −35° C.);

A-5 is Tafmer BL2481M (1-butene.α-olefin copolymer, Tg: −14° C., manufactured by Mitsui Chemicals Inc.);

B-1 is isostearyl acrylate having a branched structure represented by the following formula, which is prepared from isostearyl alcohol by a dehydration ester method and has a sulfur content of 302 ppm;

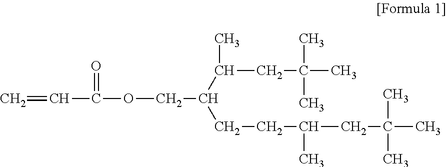 [SMILES: C=CC(=O)OCC(CCC(C)CC(C)(C)C)C(C)CC(C)(C)C]

B-2 is isostearyl acrylate of B-1 with sulfur content reduced to 18 ppm;

B-3 is hexadecyl acrylate (cetyl acrylate) produced by the dehydration ester method;

B-4 is A-DOD-N (1,10-decanediol diacrylate, manufactured by Shin-Nakamura Chemical Co., Ltd.);

B-5 is CN9014NS (urethane acrylate on both terminal ends of hydrogenated polybutadiene, manufactured by Arkema S.A.);

C-1 is 1,2,3-triazole (HSP: δD=20.1, δP=16.2, δH=13.7, manufactured by Otsuka Chemical Co., Ltd.);

C-2 is 1,2,3-benzotriazole (HSP: δD=20.9, δP=12.4, δH=9.0, manufactured by Johoku Chemical Co., Ltd.);

Omnirad 651 is a photopolymerization initiator, manufactured by BASF;

Omnirad TPO-G is a photopolymerization initiator, manufactured by BASF;

Quinton R100 is a petroleum resin for dicyclopentadiene-based C5 fraction, manufactured by Zeon Corporation);

Irganox 1076 is a hindered phenolic antioxidant, manufactured by BASF.

The “acrylic adhesive-1” was obtained by the following method: 60 parts by mass of butyl acrylate (BA), 40 parts by mass of lauryl acrylate, 1 part by mass of 4-hydroxybutyl acrylate (HBA), and 0.1 part by mass of 2,2′-azobisisobutylonitrile as a polymerization initiator were charged together with 200 parts by mass of ethyl acetate; nitrogen gas was introduced therein while stirring to be replaced with nitrogen for 1 hour; polymerization reaction was performed for 10 hours while maintaining the liquid temperature in the flask at about 55° C. to prepare a polymer solution; and then, a trimethylolpropane adduct of xylylene diisocyanate (trade name: D110N, manufactured by Mitsui Chemicals Inc.) as a crosslinking agent was blended in the polymer solution obtained above in an amount of 0.5 part by mass relative to 100 parts by mass of the solid content of the polymer, and was dried (HSP: δD=16.5, δP=2.7, δH=3.9).

<Various Evaluations>

The adhesive sheet (sample) obtained by peeling the mold release film from the adhesive sheet-layered product obtained in each of Examples and Comparative Examples was subjected to various evaluations by the following methods. The results are shown in Table 2.

(Total Content of Cl, Br, I, and S)

The content mass of each of Cl, Br, I, and S in the adhesive sheet (sample) was quantified by the following method, and the contents were summed.

The contents of Cl, Br, and S were quantified as follows: the adhesive sheet (sample) was combusted and decomposed by a sample combustion device (AQF-200M, manufactured by Mitsubishi Chemical Analytech Co., Ltd.); the generated gas was collected in an absorbent to form a sample solution; and the amounts of Cl, Br, and S in the sample solution were quantified by a calibration curve method using an ion chromatography (ICS-1600, manufactured by Thermo Fisher Scientific Inc.).

The content of I was quantified as follows: the adhesive sheet (sample) was combusted and decomposed by a sample combustion device (AQF-200M, manufactured by Mitsubishi Chemical Analytech Co., Ltd.); the generated gas was collected in an absorbent to form a sample solution; and the amount of I in the sample solution was quantified by a calibration curve method using an inductively coupled plasma mass spectrometer (Agilent 7500, manufactured by Agilent Technologies, Inc.).

(Confirmation of Uneven Distribution of Triazole Compound)

Using an X-ray electron spectroscopy analyzer (K-Alpha, manufactured by Thermo Fisher Scientific Inc.) under the following conditions, four kinds of atoms of carbon, oxygen, silicon, and nitrogen in the adhesive sheet (sample) were scanned 40 times or more at every 100 seconds while performing Ar etching, to obtain an atomic concentration profile in the thickness direction of each atom. From the obtained data, a graph in which a value (N/C) obtained by dividing the nitrogen atom concentration by the carbon atom concentration was taken on the vertical axis, and the etching time was taken on the horizontal axis, was prepared. An example of the graph is shown in FIG. 1.

From the graph, the difference between the value (N/C) after 100 seconds of etching and the value (N/C) after 4,000 seconds of etching was determined. When the difference was 0.01 or more, it was evaluated as “O” assuming that the triazole compound was unevenly distributed, and when the difference was less than 0.01, it was evaluated as “X” assuming that the triazole compound was not unevenly distributed.

Here, the reason for the low N/C in the first scan (before etching) in FIG. 1 was due to the influence of the transferred silicone release of the separator.

<Measurement Conditions>

Measurement area: ϕ400 pm

Path energy: 50 eV

Number of scanning times: 5 times

<Etching Conditions>

Ion energy: 1,000 eV

Raster size: ϕ2 mm

(Corrosion Resistance Reliability)

A silver nanowire coating liquid (manufactured by C3Nano Inc.) was applied to a PET film of 50 μm to obtain a transparent electrode film of 50 Ω/□. The obtained transparent electrode film was cut into a strip having a width of 9 mm, five strip-shaped transparent electrode films were arranged on a glass substrate with the conductive surface facing upward, and the ends were fixed with tape. Further, silver paste was applied to both ends of the transparent electrode films to prepare contacts for resistance measurement. The adhesive sheet (sample) cut into a width of 50 mm was bonded thereon using a hand roll such that the adhesive layer was in direct contact with the transparent electrode surface. The measuring method is shown in FIG. 2.

The layered product thus bonded was stored in an environment of 65° C. and 90% Rh, and the change in resistance value (kΩ) of the transparent electrode was recorded.

After being stored for 1,200 hours, those that did not exceed 1.5 kΩ were evaluated as “O” and those that exceeded were evaluated as “X”.

(Haze)

For the adhesive sheet (sample) having glass bonded on both surfaces, the total light transmittance according to JIS K7361-1 and the haze according to JIS K7136 were respectively measured using a haze meter (NDH5000, manufactured by Nippon Denshoku Industries Co., Ltd.).

(Relative Permittivity)

A plurality of the adhesive sheets (samples) was laminated to obtain a sheet having a thickness of 500 μm. The sheet was adjusted to a width of 25 mm and a length of 25 mm, and the permittivity was then measured at a frequency of 100 MHz using an impedance measuring apparatus (4291B, manufactured by HP Japan Inc.).

(Glass Transition Temperature)

A plurality of the adhesive sheets (samples) was laminated to produce a sheet having a thickness of about 2 mm. The obtained sheet punched into a circle with a diameter of 20 mm was subjected to a measurement using a rheometer (MARS, manufactured by Eko Instruments Co., Ltd.) under the conditions where the adhesive jig was ϕ20 mm parallel plate, strain was 0.1%, frequency was 1 Hz, temperature was −50 to 150° C., and temperature rise rate was 3° C. /min, thereby obtaining a peak temperature of the loss tangent as the glass transition temperature (Tg).

The results of the obtained resin compositions are shown in Table 2.

TABLE 2

| | | | | | | | | | Comparative | Comparative |
|---|---|---|---|---|---|---|---|---|---|---|
| | | | | Example 1 | Example 2 | Example 3 | Example 4 | Example 5 | Example 1 | Example 2 |
| Cl content | | | ppm | 22.9 | 23.4 | 22.1 | 7.2 | 6.9 | 8.4 | 21.7 |
| Br content | | | | <3 | <3 | <3 | <3 | <3 | <3 | <3 |
| I content | | | | <1 | <1 | <1 | <1 | <1 | <1 | <1 |
| S content | | | | 12.7 | 12.6 | 15.8 | 23.3 | 19.9 | 31.8 | 16.7 |
| Total content of Cl, Br, I, | | | | 35.6 | 36.2 | 37.9 | 30.5 | 26.8 | 40.2 | 38.4 |
| and S | | | | | | | | | | |
| Whether nitrogen | | | | ◯ | ◯ | ◯ | ◯ | ◯ | X | — |
| heterocyclic compounds | | | | | | | | | | |
| are unevenly distributed | | | | | | | | | | |
| Relative | 100 | kHz | | 2.44 | 2.44 | 2.56 | 2.2 | 2.12 | 3.86 | 2.56 |
| permittivity | | | | | | | | | | |
| Ag | Initial | | kΩ | 0.55 | 0.55 | 0.57 | 0.59 | 0.56 | 0.57 | 0.66 |
| nanowire | stage of | | | | | | | | | |
| electrode | adhesion | | | | | | | | | |
| resistance | 150 | h | | 0.81 | 0.57 | 0.6 | 0.67 | 0.61 | 0.93 | 4.53 |
| (60° C. 90% | 300 | h | | 1.1 | 0.62 | 0.63 | 0.93 | 0.62 | 1.16 | disconnected |
| Rh) | 800 | h | | 1.13 | 0.67 | 0.65 | 0.94 | 0.62 | 3.07 | — |
| | 1200 | h | | 1.13 | 0.85 | 0.83 | 0.97 | 0.65 | 5.8 | — |

| | | | | | | | | |
|---|---|---|---|---|---|---|---|---|
| Corrosion resistance reliability | | ◯ | ◯ | ◯ | ◯ | ◯ | X | X |
| Haze | % | 0.6 | 0.6 | 0.6 | 0.3 | 0.3 | 0.6 | 0.6 |
| Tg | ° C. | −2 | −2 | −18 | −20 | −20 | −35 | −18 |

(Consideration.)

From the results of the Examples and the tests which have been so far conducted by the present inventors, it can be confirmed that, when the adhesive layer of the adhesive sheet contained. a polyolefin, an acrylic polymer, and a triazole compound as a nitrogen heterocyclic compound, the relative per and its temperature dependence could be reduced, and at the same time, the corrosion prevention effect could. he obtained.

Also, it can be confirmed that the corrosion prevention effect could he further enhanced by setting the total content of the halogen elements and sulfur contained in the adhesive sheet to a certain value or less.

In addition, when. the adhesive layer contained. a polyolefin and an acrylic polymer, the rust inhibitor was unevenly distributed on the surface of the adhesive layer compared with the adhesive layer containing no polyolefin. Thus, it can be confirmed that the corrosion prevention effect could be exhibited over a long period of time even for silver or copper, which were easily corroded.

1. An adhesive sheet of a single layer comprising:
an adhesive layer comprising a polyolefin, an acrylic polymer, and a nitrogen heterocyclic compound.

2. An adhesive sheet having a layered constitution comprising an adhesive layer comprising a polyolefin, an acrylic polymer, and a nitrogen heterocyclic compound,
wherein the adhesive layer is provided as a surface layer.

3. The adhesive sheet according to claim 1, wherein the nitrogen heterocyclic compound is more unevenly distributed on an adhesive layer surface than an inside of the adhesive layer.

4. The adhesive sheet according to claim 1, wherein the adhesive sheet has a total content mass of Cl, Br, I and S of 100 ppm or less.

5. The adhesive sheet according to claim 1, wherein the adhesive sheet has a relative permittivity of 3.8 or less at a frequency of 100 kHz.

6. The adhesive sheet according to claim 1, wherein the polyolefin is
a polymer of any one of polyisobutylene, polybutene, polybutadiene, and polyisoprene;
a hydrogen additive polymer of any one of polyisobutylene, polybutene, polybutadiene, and polyisoprene;
a polymer having the polymer or hydrogen additive polymer of any one of polyisobutylene, polybutene, polybutadiene, and polyisoprene as a main chain;
a copolymer comprising a combination of monomers constituting the polymers or hydrogen additive polymers of any two or more of polyisobutylene, polybutene, polybutadiene, and polyisoprene; or
a mixed resin comprising a combination of the polymers of any two or more of polyisobutylene, polybutene, polybutadiene, and polyisoprene.

7. The adhesive sheet according to claim 1, wherein the adhesive sheet has a haze of 1.0% or less.

8. A conductive member-layered product, comprising:
the adhesive sheet according to claim 1 and a conductive member.

9. A touch panel, comprising:
the conductive member-layered product according to claim 8.

10. An image display device, comprising;
the conductive member-layered product according to claim 8,
an image display panel, and
a surface protection panel.

11. The adhesive sheet according to claim 2, wherein the nitrogen heterocyclic compound is more unevenly distributed on an adhesive layer surface than an inside of the adhesive layer.

12. The adhesive sheet according to a claim 2, wherein the adhesive sheet has a total content mass of Cl, Br, I and S of 100 ppm or less.

13. The adhesive sheet according to claim 2, wherein the adhesive sheet has a relative permittivity of 3.8 or less at a frequency of 100 kHz.

14. The adhesive sheet according to claim 2, wherein the polyolefin is
a polymer of any one of polyisobutylene, polybutene, polybutadiene, and polyisoprene;
a hydrogen additive polymer of any one of polyisobutylene, polybutene, polybutadiene, and polyisoprene;
a polymer having the polymer or hydrogen additive polymer of any one of polyisobutylene, polybutene, polybutadiene, and polyisoprene as a main chain;
a copolymer comprising a combination of monomers constituting the polymers or hydrogen additive polymers of any two or more of polyisobutylene, polybutene, polybutadiene, and polyisoprene; or
a mixed resin comprising a combination of the polymers of any two or more of polyisobutylene, polybutene, polybutadiene, and polyisoprene.

15. The adhesive sheet according to claim 2, wherein the adhesive sheet has a haze of 1.0% or less.

16. A conductive member-layered product, comprising:
the adhesive sheet according to claim 2 and
a conductive member.

17. A touch panel, comprising:
the conductive member-layered product according to claim 16.

18. An image display device, comprising:
the conductive member-layered product according to claim 16,
an image display panel, and
a surface protection panel.
